(19) United States
(12) Patent Application Publication
(10) Pub. No.: US 2012/0009062 A1
(43) Pub. Date: Jan. 12, 2012

(54) Load Mitigation During Extreme Yaw Error on a Wind Turbine

(75) Inventors: Benjamin Tyler Ingram, Tustin, CA (US); Sandeep Gupta, Ventura, CA (US); Ameet Shridhar Deshpande, Ventura, CA (US); Nathaniel Brook Taylor, Santa Barbara, CA (US)

(73) Assignee: Clipper Windpower, Inc., Carpinteria, CA (US)

(21) Appl. No.: 13/193,325

(22) Filed: Jul. 28, 2011

Related U.S. Application Data
(63) Continuation-in-part of application No. PCT/IB2009/006309, filed on Jul. 22, 2009.

(51) Int. Cl. F03D 7/04; F03D 1/00

(52) U.S. Cl. 416/1; 416/41; 416/44

(57) ABSTRACT

A method for mitigating loads on a wind turbine in yaw error events is disclosed. The method may include determining a yaw error and a speed of the wind turbine and determining a magnitude of de-rating of the wind turbine based upon magnitudes of the yaw error and the speed. The method may further include reducing power output of the wind turbine based upon the magnitude of de-rating.

### CROSS-REFERENCE TO RELATED APPLICATION

This application is a Continuation-In—Part (CIP) Patent Application claiming priority under 35 U.S.C. §365(c) to International Application No. PCT/IB2009/006309 filed on Jul. 22, 2009, and also claims priority to Provisional Patent Application No. 61/206,207 filed on Jan. 28, 2009.

### FIELD OF THE DISCLOSURE

The present disclosure generally relates to wind turbines and, more particularly, relates to mitigating loads during extreme yaw error conditions experienced by wind turbines.

### BACKGROUND OF THE DISCLOSURE

A utility-scale wind turbine typically includes a set of two or three large rotor blades mounted to a hub. The rotor blades and the hub together are referred to as the rotor. The rotor blades aerodynamically interact with the wind and create lift or drag, which is then translated into a driving torque by the rotor. The rotor is attached to and drives a main shaft, which in turn is operatively connected via a drive train to a generator or a set of generators that produce electric power. The main shaft, the drive train and the generator(s) are all situated within a nacelle, which rests on a yaw system that continuously pivots along a vertical axis to keep the rotor blades facing in the direction of the prevailing wind current to generate maximum torque.

In certain circumstances, the wind direction can shift very rapidly, faster than the response of the yaw system, which can result in a yaw error. Yaw error is typically defined as the difference (e.g., angular difference) between the orientation of the wind turbine and the wind direction and it occurs when the wind turbine is not directly pointed (e.g., facing) into the wind. During such aforementioned transient wind events, the yaw error, which can be sustained for a few seconds or minutes (until the yaw system points the wind turbine to face the wind), might damage the wind turbine if operation of the wind turbine continues. Specifically, during such operation of the wind turbine, yaw error can result in unacceptably high loads on the rotor blades, hub, tower, and other components thereof, which can result in damage

Yaw error can be avoided by actively adjusting the orientation of the wind turbine with the yaw system, i.e. by keeping the wind turbine pointed directly into the wind. However, as mentioned above, the wind direction may shift quite rapidly and faster than the response of the yaw system. A technique proposed in the past handles extreme yaw error by simply shutting down the wind turbine in those extreme yaw error conditions and then restarting once the wind turbine is either properly oriented into the wind. When the wind turbine is shut down, it goes through a shut down cycle, then a start up cycle, which results in several minutes of lost energy production. In addition, high loading can occur on turbine components if we initiate shutdown during an extreme yaw error condition.

### SUMMARY OF THE DISCLOSURE

In accordance with one aspect of the present disclosure, a method for mitigating loads on a wind turbine in yaw error events is disclosed. The method may include determining a yaw error and a speed of the wind turbine and determining a magnitude of de-rating of the wind turbine based upon magnitudes of the yaw error and the speed. The method may further include reducing power output of the wind turbine based upon the magnitude of de-rating.

In accordance with another aspect of the present disclosure, a method of controlling power output of a wind turbine in extreme yaw error conditions is disclosed. The method may include providing a control system in operable association with the wind turbine, the control system receiving a yaw error signal. The method may further include determining a de-rating response of the wind turbine based upon the yaw error and reducing power output of the wind turbine based upon the de-rating response.

In accordance with yet another aspect of the present disclosure, a wind turbine is disclosed. The wind turbine may include a rotor having a hub and a plurality of blades radially extending from the hub. The wind turbine may also include a control system in operable association with the rotor, the control system may be configured to determine yaw error of the wind turbine to progressively reduce power output of the wind turbine in response to the yaw error.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is an exemplary flowchart outlining steps in mitigating high loads on the wind turbine during a yaw error;

FIG. 3 is an exemplary table representing the response of the wind turbine at varying combinations of speed and yaw error; and

FIG. 4 shows in schematic form one technique for de-rating the wind turbine.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

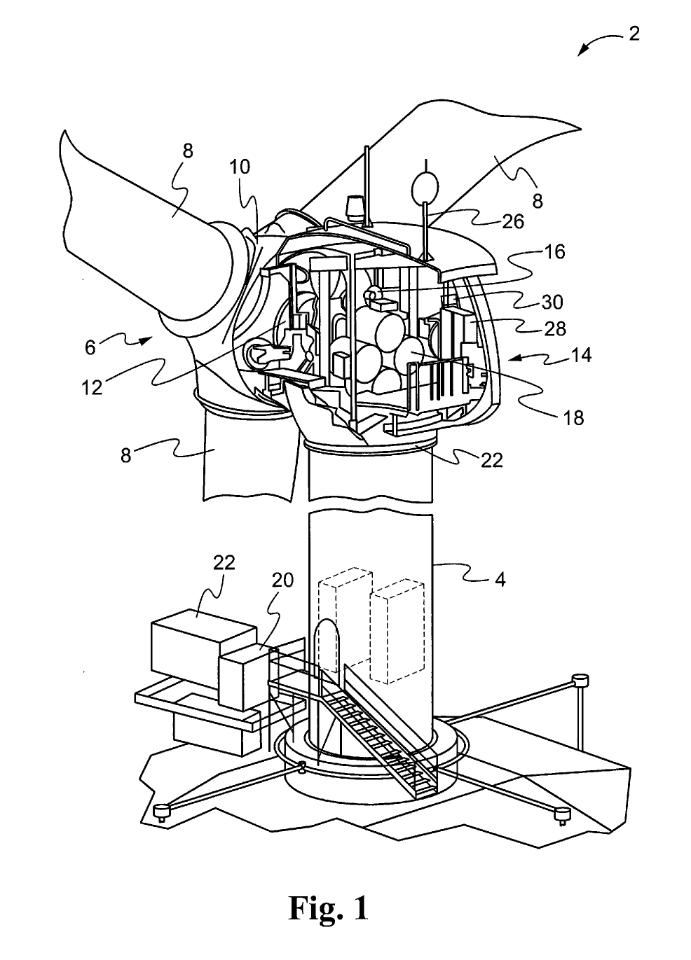

Referring to FIG. 1, an exemplary wind turbine 2 is shown, in accordance with at least some embodiments of the present disclosure. While all the components of the wind turbine have not been shown and/or described, a typical wind turbine may include a tower section 4 and a rotor 6. The rotor 6 may include a plurality of blades 8 connected to a hub 10. The blades 8 may rotate with wind energy and the rotor 6 may transfer that energy to a main shaft 12 situated within a nacelle 14. The nacelle 14 may optionally include a drive train 16, which may connect the main shaft 12 on one end to one or more generators 18 on the other end. Alternatively, the generator(s) 18 may be connected directly to the main shaft 12 in a direct drive configuration. The generator(s) 18 may generate power, which may be transmitted through the tower section 4 to a power distribution panel (PDP) 20 and a pad mount transformer (PMT) 22 for transmission to a grid (not shown). The nacelle 14 may be positioned on a yaw system 24, which may pivot about a vertical axis to orient the wind turbine 2 in the direction of the wind current. In addition to the aforementioned components, the wind turbine 2 may also include a pitch control system (not visible) having a pitch control unit (PCU) situated within the hub 10 for controlling the pitch (e.g., angle of the blades with respect to the wind direction) of the blades 8 and an anemometer 26 for measuring the speed and direction of the wind relative to the wind turbine. A turbine control unit (TCU) 28 and control system 30 may be situated within the nacelle 14 for controlling the various components of the wind turbine 2.

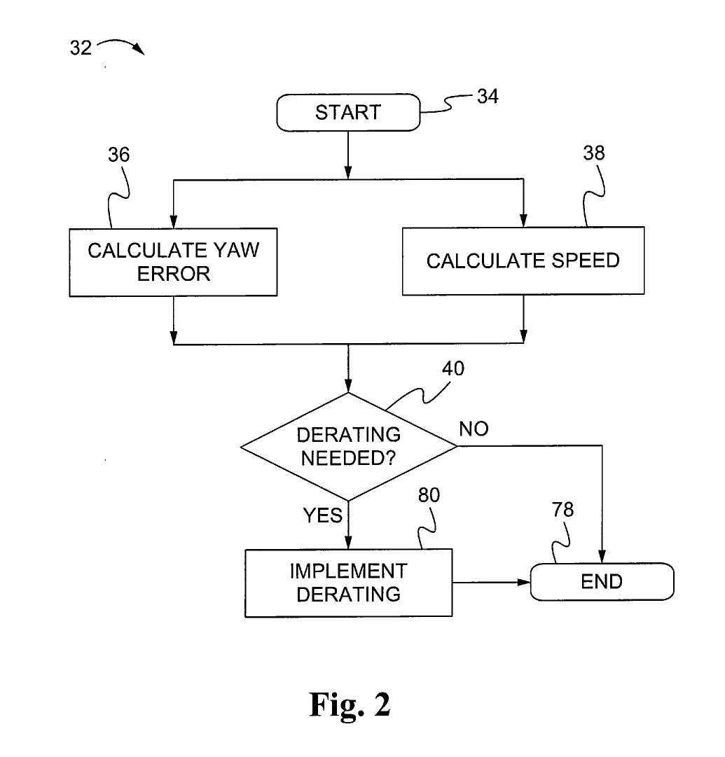

Referring now to FIG. 2, an exemplary flowchart 32 outlining steps which may be performed in reducing high loads on various components of the wind turbine 2 during extreme yaw error and excessive speeds are shown, in accordance with at least some embodiments of the present invention. As shown, after starting at a step 34, the process proceeds to steps 36 and 38 where parameters, such as, yaw error and speed, which may affect the response of the wind turbine 2 (in mitigating loads) may be determined. Specifically, at the step 36, the yaw error may be determined while at the step 38, the speed may be determined, both of the parameters being described in greater detail below. The yaw error in particular may be described as the angular difference between the orientation of the wind turbine 2 generally or the horizontal rotational axis of the rotor more specifically, and the actual direction of the wind. In at least some embodiments, the yaw error may be measured by the anemometer 26 (e.g., a sonic anemometer) or, in other embodiments, other commonly employed mechanisms, such as, a wind vane, or a forward looking remote sensing device (e.g., LIDAR) may be utilized. Furthermore, in at least some embodiments, the yaw error may be classified as an extreme yaw error when the yaw error exceeds around thirty degrees (30°) while in other embodiments, depending upon the location of the wind turbine, the height and size of the tower 4 and the rotor 6, the ranges of the extreme yaw error may vary.

With respect to the speed measured at the step 38, it may be any of a wind speed, speed of the main shaft 12, speed of the generators 18, and the like. Since, the speeds of all of the aforementioned components are closely related or dependent upon one another, the speed of any of those components may be determined at the step 38. For example, the anemometer 26 may be employed for determining the wind speed. Similarly, the speed of the main shaft 12 and/or the speed of the generators 18 may be determined by various speed sensors provided within the wind turbine 2. Furthermore, in some embodiments, a wind speed that exceeds about eighteen meters per sec (18 m/sec) may be classified as high when occurring simultaneously with large yaw errors, and may cause the wind turbine 2 to respond by mitigating loads thereon, in a manner described below, while in other embodiments, depending upon the location of the wind turbine and the wind gust pattern of that location, the height of the tower 4 and the diameter of the rotor 6, the wind speeds for which a wind turbine load mitigation action may be taken may vary.

In addition, the yaw error and the speed measured at the steps 36 and 38, respectively, may be pre-processed or filtered by the control system 30 to obtain filtered or averaged values thereof. For example, in at least some embodiments, first, the instantaneous measured values of yaw error and speed may be averaged over time (such as averaged over a five to fifteen second moving average) to smooth those signals. Subsequently, each of those signals may be scaled down by assigning a value between one (1) and zero (0), depending particularly upon the magnitude of each signal. The scaled values of the yaw error and the speed may then be utilized by the wind turbine 2 and specifically by the control system 30 of the wind turbine to determine the response thereof in mitigating loads on the various components. As will be further described below, the response of the wind turbine 2 may range from de-rating (or reducing the power output by, for example, pitch increase and/or a power set-point change) the wind turbine to eventually facilitating a compete shut-off of the wind turbine in extreme yaw error and speed conditions.

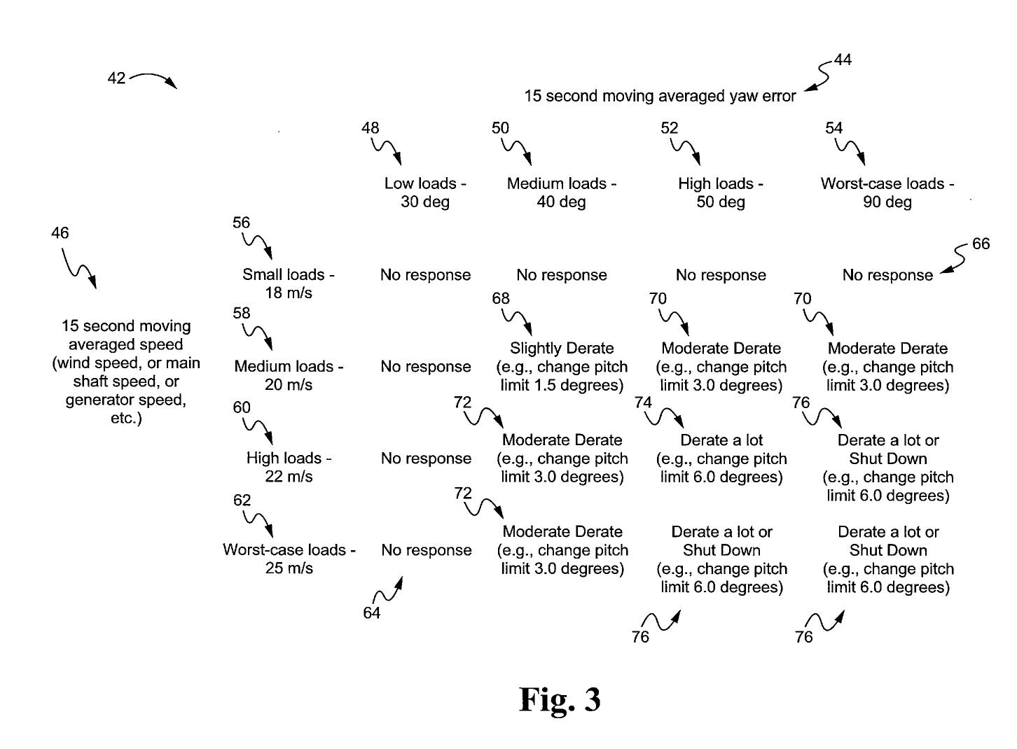

Thus, at the steps 36 and 38, the yaw error (or a scaled value thereof) and the speed (or the scaled value thereof), respectively, may be determined. Next, at a step 40, it may be determined whether any mitigation of loads on the wind turbine 2 is needed and, if so, a magnitude of the response (of load mitigation) of the wind turbine to the yaw error of the step 36 and the speed of the step 38 may be calculated. The magnitude of the response of the wind turbine 2 may vary depending upon the magnitude of the yaw error and/or the speed. For example, at higher yaw error and/or higher speeds, the response of the wind turbine 2 may be more severe compared to lower yaw errors and/or lower speeds, as described with respect to FIG. 3 below. Furthermore, the response of the wind turbine 2 may range from continuously de-rating the wind turbine (e.g., reducing the power output of the wind turbine) to reduce peak loads thereon to eventually shutting down the wind turbine at greater yaw errors (or extreme yaw errors) and/or speeds.

Referring now to FIG. 3 in conjunction with FIG. 2, a table 42 showing an exemplary response (de-rating and/or shut down) of the wind turbine 2 in reaction to yaw errors (including extreme yaw errors) and speeds is shown, in accordance with at least some embodiments of the present invention. In particular, the table 42 shows the response of the wind turbine 2 for a fifteen second moving averaged yaw error 44 along the columns of the table and a fifteen second moving averaged speed 46 along the rows of the table. Although the speed 46 shown in the table 42 is wind speed, it will be understood that the speed may be any of a rotor speed, generator speed, main shaft speed and the like as well.

Furthermore, and as mentioned above, the response of the wind turbine 2 in reaction to the yaw errors 44 and the speeds 46 may vary depending upon the magnitude of those variables. Thus, the table 42 may provide four different load values for each of the yaw errors 44 and each of the speeds 46. For example, the yaw errors 44 may be classified into low loads 48, having a yaw error up to thirty degrees (30°), medium loads 50 having a yaw error from thirty to forty degrees) (30°-40°, high loads 52 with a yaw error ranging from forty to fifty degrees) (40°-50° and worst-case loads 54 having a yaw error (or extreme yaw error) ranging from fifty degrees to ninety degrees) (50°-90° or more. Relatedly, the speed 46 may be divided into small loads 56 of speeds up to eighteen meters per second (18 m/s), medium loads 58 of speeds from eighteen meters per second to twenty meters per second (18 m/s-20 m/s), high loads 60 with speeds from twenty meters per second to twenty two meters per second (20 m/s-22 m/s) and worst-case loads 62 with speeds from twenty two meters per second to over twenty five meters per second (22 m/s-25 m/s).

Notwithstanding the fact that the present embodiment has been described with the yaw error 44 and the speed 46 divided into four different categories of load values, each category representing a specific range of loads, in other embodiments, the number of categories of loads and the values within each of those categories may vary. It will also be understood that the table 42 is merely meant to qualitatively describe the response of the wind turbine 2 in cases of extreme or non-extreme yaw error and speed for explanation purposes, and is not intended to illustrate a look-up table that may be implemented within the control system 30 to control the response thereof.

Thus, based upon the loads (small/low, medium, high or worst-case) of the yaw error 44 and the speed 46, the response of the wind turbine 2 and, particularly, the de-rating magnitude and/or shut down thereof may vary. For example, for the low loads 48 of the yaw error 44 and the small loads 56 of the speed 46, the wind turbine 2 may not have any de-rating response, as evidenced by the values of “no response” in each of the blocks in column 64 and row 66, respectively. In at least some embodiments, “no response” may mean that the wind turbine 2 may continue normal operation without any de-rating or shut-down. On the other hand, for the medium loads 50 and 58 of the yaw error 44 and the speed 46, respectively, the wind turbine 2 may be de-rated slightly (see block 68), while the high loads 52 and the worst-case loads 54 of the yaw error 44 may facilitate a moderate de-rating of the wind turbine 2 at the medium loads 58 of the speed 46, as shown by blocks 70. Relatedly, the high and worst-case loads 60 and 62, respectively, of the speed 46 may also facilitate a moderate de-rating of the wind turbine 2 for the medium loads 50 of the yaw errors 44, as shown by blocks 72.

Furthermore, the wind turbine 2 may be maximum de-rated for the high load values 52 and 60 of the yaw error 44 and the speed 46, respectively, as shown by block 74, while the worst-case loads 62 and the worst-case loads 54 may maximum de-rate the wind turbine or may eventually even force a shut-down, depending upon the values of those loads, as shown by blocks 76. Thus, as described above, the de-rating response of the wind turbine 2 may be dependent upon the magnitudes of the yaw error and the speeds, the response becoming more severe with increasing yaw error and speed.

For example, as shown, a slightly de-rate response of the block 68 in some embodiments may facilitate a pitch limit change of 1.5 degrees, while a moderate de-rate response of the blocks 70 and 72 may facilitate a pitch limit change of 3.0 degrees. Relatedly, a maximum de-rate response of the blocks 74 and 76 may produce a change of pitch limit of 6.0 degrees (if not shut down). As will be explained below, changing the pitch of the blades 8 may be employed to de-rate the wind turbine 2. It will be understood that the definitions (e.g., pitch limit change) of the qualitative responses (slightly de-rate, moderate de-rate, maximum de-rate) of the wind turbine 2 shown in the table 42 are merely one example of the wind turbine response and the definitions may vary in other embodiments. Specifically, changing of the pitch limit may be one way of controlling the de-rating response of the wind turbine 2. Several other mechanisms, another one of which will be described further below, may be employed for de-rating the wind turbine 2 as well. It will also be understood that although the table 42 has been shown and explained with certain values of changing the pitch limit, the values of the pitch limit change for those responses may vary in other embodiments.

Turning back to FIG. 2, thus, at the step 40, if no de-rating of the wind turbine 2 is needed (for example, due to the low loads 48 and 56 of the yaw error 44 and the speed 46, respectively, in FIG. 3), the wind turbine may continue normal operation without any de-rating and the process may end at step 78. On the other hand, if a de-rating response of the wind turbine 2 is indeed needed (for example, due to medium, high or worst-case loads of the yaw error 48 and the speed 46 in FIG. 3), the magnitude of the de-rating required may be determined (for example, by way of a look-up table or a mathematical function implemented in the control system 30) at the step 40 and the process may proceed to a step 80. Again, the table 42 of FIG. 3 is not intended to show a look-up table that the control system 30 may employ for determining the magnitude of de-rating. It is shown merely as an example to depict the variance of the response of the wind turbine 2 in reaction to the various load values of the yaw error and speed.

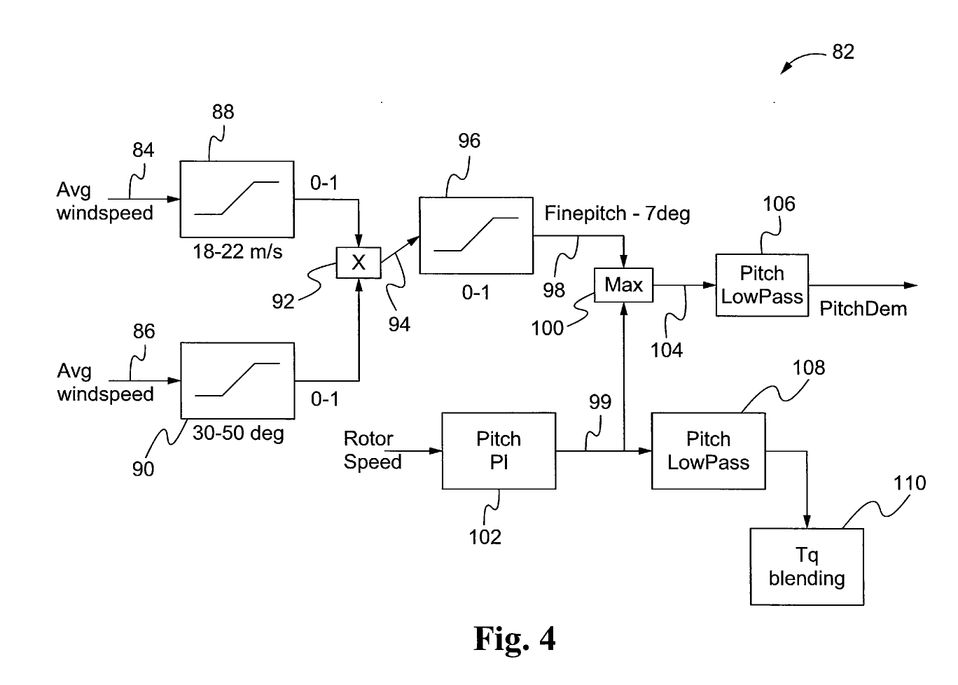

At the step 80, the de-rating of the wind turbine 2 may be implemented. Several mechanisms to de-rate the wind turbine 2 may be employed. As mentioned above, one way to de-rate the wind turbine may be to alter the pitch of the blades 8. By altering the pitch of the blades 8, they may be positioned to produce less torque, thereby reducing the power output of the wind turbine 2. Changing (e.g., increasing) the pitch of the blades 8 may be implemented as a mathematical function within the control system 30 of the wind turbine 2, as shown in FIG. 4 below or, alternatively it may be implemented as a look-up table or some other control technique.

Referring to FIG. 4 in conjunction with FIG. 2, a mathematical implementation 82 of varying the pitch of the blades 8 within the control system 30 is shown, in accordance with at least some embodiments of the present disclosure. Specifically, at any given moment, the control system 30 may produce a pitch demand or command signal, which may be executed by the pitch control system to alter the pitch angle of the blades 8 to that demanded or commanded pitch generated by the control system. This pitch demand or command signal could be limited in a way to ensure that a certain pitch position is not surpassed.

The control system 30 may receive a speed signal 84 and a wind direction or yaw error or wind direction signal 86, both of which may be pre-processed, for example as described above, by averaging over time, such as a 5-15 sec. moving average to smooth the signal. The smoothed signals 84 and 86 may then be scaled between one (1) and zero (0), as shown by respective blocks 88 and 90. The scaled numbers between one (1) and zero (0) may then be multiplied within a multiplier 92 to create a product 94 thereof. The product 94 may be scaled again within block 96 to produce a minimum pitch limit 98 (e.g., maximum amount that the blades 8 may be pitched towards the wind for making power) that may range between one degree (1°) or finepitch (where the blades 8 are positioned to produce maximum power) and seven degrees (7°). The minimum pitch limit 98 may vary in other embodiments and may be compared within a comparator 100 with a pitch demand 99 coming out of a block 102. The comparator 100 may determine a maximum 104 of the two values: the pitch demand 99 determined by the TCU and the pitch limit 98 computed by the control system 30. It should be understood that a zero degree (0°) pitch angle may generate the most lift and torque (and hence maximum power) during operation when the rotor 6 is turning at a certain RPM.

It will be understood that in at least some embodiments and as intended in this disclosure, a higher value of pitch limit is equivalent to reducing the maximum lift force on the blades 8, and thus the power generated. This maximum (limited) value 104 may then proceed through the remainder of the control system (blocks 106, 108, and 110), eventually being sent to the pitch control unit (PCU), which may regulate the blade angles to the demanded value. The “remainder” of the control system (the blocks 106, 108 and 110) is beyond the scope of this disclosure, and can vary significantly between wind turbine designs. For example, in the exemplary embodiment, the blocks 106 and 108 may be low pass filters that may reduce the current and number of direction changes required of the pitch system. The block 110 on the other hand may be a coupling between the pitch control and generator torque control algorithms.

Thus, depending upon the magnitude of the yaw error and the speed, the magnitude of pitch of the blades 8 may be varied by the control system 30 to de-rate or reduce the power output of the wind turbine. It will be understood that the aforementioned technique of modifying the pitch angle is one exemplary way of doing so. Other mechanisms for varying the pitch angle of the blades 8 may be implemented in other embodiments. Returning back to FIG. 2, methods other than adjusting the pitch angle of the blades 8 for de-rating the wind turbine 2 may be employed as well. For example, the control system 30 may be programmed with a set-point that may specify the amount of power to produce, or the target generator or main shaft speed and/or required torque for any given speed. That set-point may be temporarily reduced during the yaw error and/or speed condition, to mitigate loads on the wind turbine by producing less power. The set-point may return to normal once the yaw error and/or speed conditions have passed, i.e. once the yaw system points the wind turbine 2 into the wind again. Similar to the pitch control method, the magnitude of set-point reduction may depend upon the magnitude of the yaw error and speed. A higher or extreme yaw error and speeds may facilitate a greater reduction of the set-point, as compared to lower values thereof.

Several other techniques that are commonly employed may additionally be utilized for de-rating the wind turbine 2. Furthermore, the pitch control mechanism or the set-point reduction method or any other technique that is employed for de-rating the wind turbine 2 may be employed either individually or in combination with one or more of the other techniques. Also, if any of the aforementioned techniques for de-rating the wind turbine 2 are not sufficient for reducing loads thereon, the wind turbine may be eventually shut down to prevent damage to any of its components. After de-rating or shutting down the wind turbine 2 at the step 80, the process ends at the step 78.

In general, the present disclosure sets forth a control mechanism for mitigating high loads during a yaw error by temporarily lowering the power output of the wind turbine. Specifically, the control mechanism causes the wind turbine to reduce power output, i.e. de-rate the wind turbine, during an extreme yaw error event. An extreme yaw error event may be classified as yaw error greater than thirty to fifty degrees and a speed greater between eighteen to twenty two meters per second. The de-rating response of the wind turbine may be progressive, such that the amount of de-rating is dependent upon the severity of the operating conditions that might result in damaging loads.

By virtue of employing the above control mechanism, the wind turbine may not only be protected against extreme yaw error conditions and the damaging loads they could produce, it may continue to generate some power during such events, thereby preventing any unnecessary shut downs. When the power output of the wind turbine goes down due to de-rating, the stresses and strains on all the structures and components of the wind turbine are reduced, preventing damage to those components and leaving an adequate margin in case an any off-axis wind gust while the wind turbine is pointed in the wrong direction. Also, de-rating by changing the pitch limit of the blades elicits a faster de-rating response, while preventing any stalls of the wind turbine.

Furthermore, the aforementioned control system may be implemented as an add-on to any existing control system without requiring any modification or any substantial re-programming thereof. Accordingly, depending upon the requirements for a particular wind turbine, the de-rating control may be easily tailored to meet specific needs and added to the default control system of the wind turbine.

While only certain embodiments have been set forth, alternatives and modifications will be apparent from the above description to those skilled in the art. These and other alternatives are considered equivalents and within the spirit and scope of this disclosure and the appended claims.

We claim:

1. A method for mitigating loads on a wind turbine in yaw error events, the method comprising:
determining a yaw error and a speed of the wind turbine;
determining a magnitude of de-rating of the wind turbine based upon magnitudes of the yaw error and the speed; and
reducing power output of the wind turbine based upon the magnitude of de-rating.

2. The method of claim 1, wherein determining the yaw error and the speed comprises determining scaled values of the yaw error and the speed.

3. The method of claim 2, wherein determining the scaled values of the yaw error and the speed comprises:
averaging instantaneous values of the yaw error and the speed over a moving average or a low pass filter to obtain smooth signals of the yaw error and the speed; and
scaling the smooth signals of the yaw error and the speed to values between one and zero.

4. The method of claim 3, wherein the instantaneous values of the yaw error and the speed are measured by an anemometer.

5. The method of claim 3, wherein the moving average is an average over five to fifteen seconds.

6. The method of claim 1 wherein the speed is one of a wind speed, rotor speed, main shaft speed and generator speed.

7. The method of claim 1, wherein the magnitude of de-rating is a monotonically increasing function of the yaw error and the speed.

8. The method of claim 1, wherein the yaw error and the speed are extreme yaw errors when the yaw error exceeds thirty degrees and the speed exceeds eighteen meters per second.

9. The method of claim 1, wherein reducing power output of the wind turbine comprises shutting down the wind turbine in extreme yaw error conditions.

10. The method of claim 1, wherein reducing power output of the wind turbine comprises altering a minimum pitch angle of blades of the wind turbine.

11. The method of claim 1, wherein reducing power output of the wind turbine comprises reducing a set point within a control system of the wind turbine.

12. The method of claim 1, wherein reducing power output of the wind turbine mitigates peak loads on the wind turbine, preventing damage thereto.

13. A method of controlling power output of a wind turbine in extreme yaw error conditions, the method comprising:
providing a control system in operable association with the wind turbine, the control system receiving a yaw error signal;
determining a de-rating response of the wind turbine based upon the yaw error; and
reducing power output of the wind turbine based upon the de-rating response.

14. The method of claim 13, wherein reducing the power output of the wind turbine is implemented as one or both of a look-up table and a mathematical function.

15. The method of claim 13, wherein the de-rating response is one of a no-response, slightly de-rate, moderate de-rate, maximum de-rate and shut down.

16. The method of claim 13, wherein reducing the power output of the wind turbine comprises one or both of increasing a pitch angle of blades of the wind turbine and reducing a set point within the control system.

17. A wind turbine, comprising:
a rotor having a hub and a plurality of blades radially extending from the hub;
a control system in operable association with the rotor, the control system configured to determine yaw error of the wind turbine to progressively reduce power output of the wind turbine in response to the yaw error.

18. The wind turbine of claim 17, wherein to determine the yaw error, the control system receives one of an instantaneous and averaged/filtered wind direction signal and a speed signal.

19. The wind turbine of claim 17, wherein the control system further receives a speed signal to progressively reduce the power output of the wind turbine.

20. The wind turbine of claim 17, wherein the control system progressively reduces power output of the wind turbine depending upon the severity of the yaw error by one or more of (1) instructing a pitch control unit to increase a pitch angle of each of the plurality of blades; (2) reducing a set-point value set within the control system; and (3) shutting down the wind turbine.
